(19) United States
(12) Patent Application Publication
(10) Pub. No.: US 2008/0266280 A1
(43) Pub. Date: Oct. 30, 2008

(54) Plasma display and control method thereof

(76) Inventors: Jin-Ho Yang, Suwon-si (KR); Hyeong-Mo Lee, Suwon-si (KR); Hwa-Seok Yoon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/148,561

(22) Filed: Apr. 21, 2008

(30) Foreign Application Priority Data
Apr. 25, 2007 (KR) 10-2007-0040248

(51) Int. Cl. G06F 3/038; G09G 3/28

(52) U.S. Cl. 345/211; 345/60

(57) ABSTRACT

A plasma display and a driving method thereof are disclosed. The plasma display includes a scan electrode, a scan integrated circuit, and a voltage supply unit. The scan integrated circuit applies a scan voltage and a non-scan voltage to the scan electrode during an address period. The voltage supply unit gradually decreases a voltage at the scan electrode to a first voltage during a reset period and supplies the scan voltage to the first terminal during the address period. The voltage supply unit includes a voltage generator that is connected to the first terminal to generate a second voltage by using the scan voltage during the reset period, and a first capacitor that is connected to the voltage generator, the first terminal, and a power source input terminal of the scan integrated circuit, and uses the second voltage supplied from the voltage generator to drive the scan integrated circuit.

### CROSS-REFERENCE TO RELATED APPLICATION

This application claims priority to and the benefit of Korean Patent Application No. 10-2007-0040248 filed in the Korean Intellectual Property Office on Apr. 25, 2007, the entire contents of which are incorporated herein by reference.

### BACKGROUND

1. Field

The field relates to a plasma display and a driving method thereof.

2. Description of the Related Technology

A plasma display is a flat panel display that uses plasma generated by gas discharge to display characters or images. It includes, depending on its size, more than several scores to millions of pixels arranged in a matrix pattern.

In general, on a panel of the plasma display, a frame is divided into a plurality of subfields, each having a gray scale weight. Gray scales are expressed by a combination of weights of subfields when a display operation is generated. Each subfield includes a reset period, an address period, and a sustain period. A wall charge state of a discharge cell is initialized in the reset period. Turn-on cells are selected in the address period, and a sustain discharge operation is performed in the turn-on cells to display an image during the sustain period.

A general plasma display applies a voltage that is greater than a scan voltage to a scan electrode at the end of a reset period, where the applied voltage may be the same as that used for selecting a turn-on cell during an address period. A driving circuit used for this process will be described with reference to FIG. 1.

FIG. 1 shows a part of a conventional driving apparatus of a plasma display that drives a scan electrode.

As shown in FIG. 1, the driving apparatus 10 includes a transistor YscL, a Zener diode ZD1, and a transistor Yfr. A drain of the transistor YscL is coupled to a scan electrode Y and a source of the transistor YscL is coupled to a power source VscL for supplying a VscL voltage, and a cathode of the Zener diode ZD1 is coupled to the scan electrode Y and an anode of the Zener diode ZD1 is coupled to a drain of the transistor Yfr. A source of the transistor Yfr is coupled to the power source VscL.

During the reset period, the transistor Yfr is turned on, and the transistor YscL is turned off. As a result, a current path from the scan electrode Y to the power source VscL through the Zener diode ZD and the transistor Yfr is formed, and a voltage applied to the scan electrode Y by the Zener diode ZD is maintained to be greater than the VscL voltage by a voltage ΔV. Here, ΔV is a breakdown voltage of the Zener diode ZD1, and the value thereof varies depending on the type of the Zener diode ZD.

When a voltage at the scan electrode Y decreases, a reset discharge is generated by a voltage difference between the sustain electrode X and the scan electrode Y. In some embodiments, the VscL voltage is −200 V, and a Zener diode ZD having a breakdown voltage of about 25V is used to correspond to heat caused by the reset discharge.

In some embodiments, since the heat is increased when the number of turn-on operations of the transistor Yfr is large (i.e., when the number of operations for applying a reset waveform is large), it is beneficial to use a Zener diode having a greater breakdown voltage or to use a plurality of Zener diodes coupled in parallel.

However, power consumption and manufacturing cost of the plasma display are increased when using a Zener diode having a greater breakdown voltage. In addition, when using a plurality of Zener diodes coupled in parallel, currents flowing to the respective Zener diodes have large deviations, and therefore circuit stability may not be adequate.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display including a scan electrode, a scan integrated circuit configured to apply a scan voltage received through a first terminal to the scan electrode and to apply a non-scan voltage through a second terminal to the scan electrode during an address period, where the non-scan voltage is greater than the scan voltage, and a voltage supply unit configured to gradually decrease a voltage at the scan electrode to a first voltage during a reset period and to supply the scan voltage to the first terminal during the address period, where the first voltage is greater than the scan voltage, where the voltage supply unit includes a voltage generator electrically connected to the first terminal and configured to during the reset period, generate a second voltage by using the scan voltage, and a first capacitor connected to a node of the voltage generator, to the first terminal, and to a power source input terminal of the scan integrated circuit, where the first capacitor uses the second voltage supplied from the voltage generator to drive the scan integrated circuit, where the second voltage corresponds to a voltage difference between the first voltage and the scan voltage.

Another aspect is a driving method of a plasma display including a Zener diode including a cathode electrically connected to a scan electrode, a first switch connected between the anode of the Zener diode and a first power source configured to supply a scan voltage, and a second switch electrically connected between the scan electrode and the first power source, the driving method including during a reset period, turning on the first switch to charge a breakdown voltage of the Zener diode to a first capacitor connected in parallel to the Zener diode, during an address period, turning on the second switch to recover the breakdown voltage to a second capacitor including a terminal connected to a node of the scan electrode and the second switch, and another terminal connected to the first capacitor, and during the address period, supplying the recovered breakdown voltage to a neighboring circuit as a power source voltage.

Another aspect is a plasma display including a scan electrode, a scan driver circuit, including a Zener diode, and a first capacitor connected in parallel with the Zener diode, where the scan driver circuit is configured to provide a reset voltage to the scan electrode during a reset period, where the first capacitor is charged to the breakdown voltage of the Zener diode, and to provide a scan voltage to the scan electrode during an address period, where the capacitor is discharged.

### BRIEF DESCRIPTION OF THE DRAWINGS

FIG. 1 shows a part of a driving apparatus of a plasma display that drives a scan electrode.

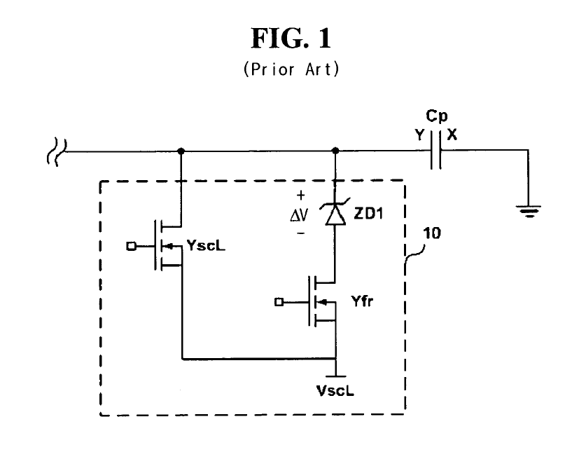

FIG. 2 is a block diagram of a plasma display according to an embodiment.

FIG. 3 is a diagram representing a driving waveform of the plasma display according to an embodiment.

FIG. 4 is a diagram representing a part of a scan electrode driver according to an embodiment.

FIG. 5 is a detailed diagram representing driving waveforms from the falling period of the reset period to the address period of the driving waveforms shown in FIG. 3.

FIG. 6 is a diagram representing first to fourth current paths \textcircled{1} to \textcircled{4} for realizing the driving waveforms shown in FIG. 5 by using the scan electrode driver of an embodiment.

### DETAILED DESCRIPTION OF CERTAIN INVENTIVE EMBODIMENTS

In the following detailed description, only certain embodiments have been shown and described, simply by way of illustration. As those skilled in the art would realize, the described embodiments may be modified in various different ways, without departing from the spirit or scope of the present invention. Accordingly, the drawings and description are to be regarded as illustrative in nature and not restrictive. Like reference numerals generally designate like elements throughout the specification.

Throughout this specification and the claims that follow, when it is described that an element is “coupled” to another element, the element may be “directly coupled” to the other element or coupled to the other element through a third element.

The wall charges being described in the present invention are charges formed on a wall (e.g., a dielectric layer), and are typically “close to each electrode of a discharge cell. The wall charges will be described as being “formed” or “accumulated” on the electrode, although the wall charges do not actually touch the electrodes. Further, a wall voltage is a potential difference formed on the wall of the discharge cell by the wall charges.

When it is described in the specification that a voltage is maintained, it should not be understood to strictly imply that the voltage is maintained exactly at a voltage. To the contrary, even if a voltage difference varies, the voltage difference is expressed to be maintained at a voltage in the case that the variation is within a range allowed in design constraints or in the case that the variation is caused by a parasitic component, and is usually disregarded by a person of ordinary skill in the art. In addition, since threshold voltages of semiconductor elements (e.g., a transistor and a diode) are very low compared to a discharge voltage, they may be considered to be 0V.

A plasma display according to an embodiment and a driving method thereof will now be described with reference to the figures.

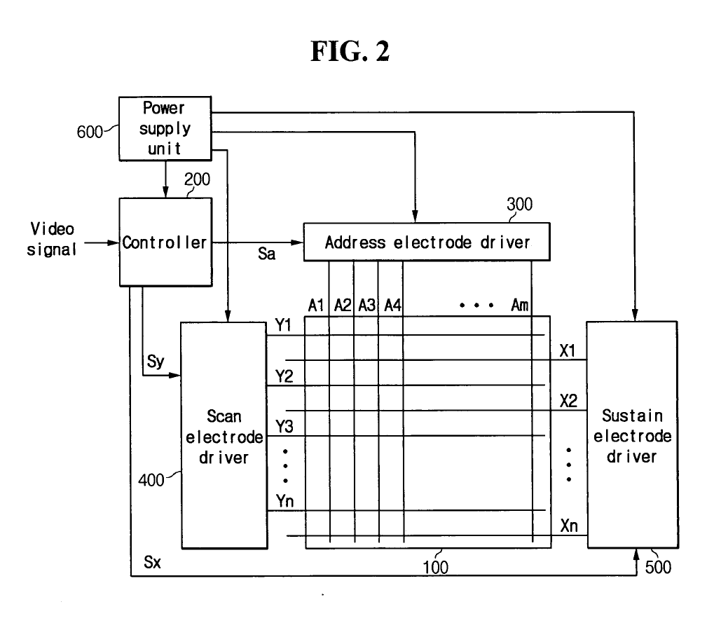

FIG. 2 is a block diagram of a plasma display according to an embodiment.

As shown in FIG. 2, the plasma display includes a plasma display panel (PDP) 100, a controller 200, an address electrode driver 300, a scan electrode driver 400, a sustain electrode driver 500, and a power supply unit 600.

The PDP 100 includes a plurality of address electrodes A1 to Am extending in a column direction, and a plurality of sustain electrodes X1 to Xn and a plurality of scan electrodes Y1 to Yn extending in a row direction. Typically, the sustain electrodes X1 to Xn are formed to correspond to the respective scan electrodes Y1 to Yn, and respective ends thereof are coupled to each other. In addition, the PDP 100 includes a substrate in which the sustain and scan electrodes X1 to Xn and Y1 to Yn are arranged (not shown), and another substrate in which the address electrodes A1 to Am are arranged (not shown). The two substrates are placed facing each other with a discharge space therebetween so that the scan electrodes Y1 to Yn and the address electrodes A1 to Am substantially perpendicularly cross each other and the sustain electrodes X1 to Xn and the address electrodes A1 to Am substantially perpendicularly cross each other. In this case, a discharge space formed near a crossing region of the address electrodes A1 to Am and the sustain and scan electrodes X1 to Xn and Y1 to Yn forms a discharge cell. This is one structure of the PDP 100, and panels of other structures can be applied to the present invention.

The controller 200 receives external video signals and outputs an address electrode driving control signal Sa, a sustain electrode driving control signal Sx, and a scan electrode driving control signal Sy. In addition, the controller 200 divides each frame into a plurality of subfields and drives the subfields, where each subfield includes a reset period, an address period, and a sustain period.

The address electrode driver 300 receives the address electrode driving control signal Sa from the controller 200, and applies a display data signal to the respective address electrodes A1 to Am so as to select discharge cells to be illuminated.

The scan electrode driver 400 receives the scan electrode driving control signal Sy from the controller 200 and applies a driving voltage to the scan electrodes Y1 to Yn.

The sustain electrode driver 500 receives the sustain electrode driving control signal Sx from the controller 200 and applies a driving voltage to the sustain electrode X1 to Xn.

The power supply 600 supplies power for driving the plasma display to the controller 200 and the respective drivers 300, 400, and 500.

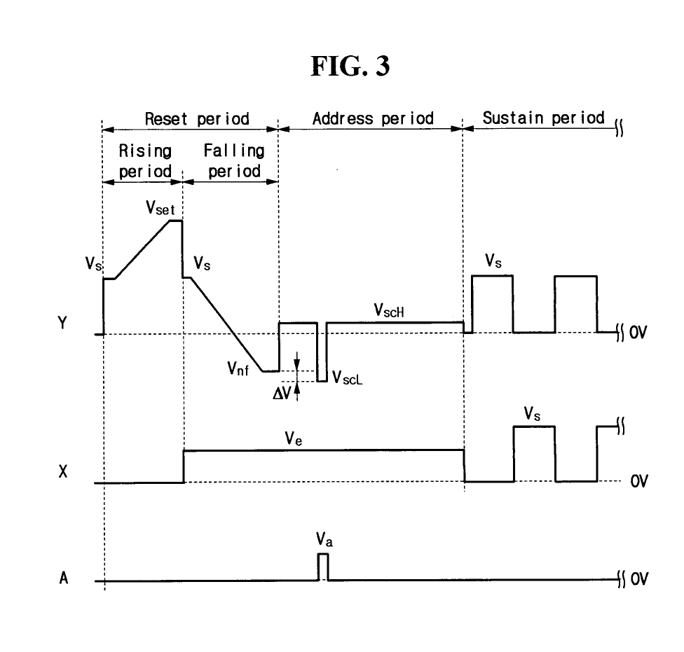

FIG. 3 is a diagram representing a driving waveform of the plasma display according to the exemplary embodiment of the present invention.

In FIG. 3, for convenience of description, only one subfield of the plurality of subfields is illustrated, and a driving waveform applied to the scan electrode Y, the sustain electrode X, and the address electrode A of the same cell will be described.

The reset period includes a rising period and a falling period. During the rising period, a voltage of the scan electrode Y is gradually increased from the Vs voltage to the Vset voltage while the address electrode A and the sustain electrode X are maintained at reference voltages (0V in FIG. 3). As a result, a weak discharge is generated between the scan electrode Y and each of the sustain electrode X and the address electrode A. Negative (−) wall charges are formed on the scan electrode Y, and positive (+) wall charges are formed on the sustain electrode X and the address electrode A. Since cells are initialized in the reset period, the Vset voltage is set high enough to sufficiently generate a discharge in the cells, regardless of their present state. In addition, while it is illustrated in FIG. 3 that the voltage at the scan electrode Y is increased or decreased in a ramp pattern, a gradually increasing or gradually decreasing waveform of other shapes may be applied.

During the falling period, the voltage of the scan electrode Y is gradually decreased from the Vs voltage to the Vnf voltage while the address electrode A and the sustain electrode X are respectively maintained at a reference voltage and the Ve voltage. As a result, a weak discharge is generated between the scan electrode Y and each of the sustain electrode X and the address electrode A, where the (−) wall charges formed on the scan electrode Y and the (+) wall charges formed on the sustain electrode X and the address electrode A during the rising period are substantially eliminated. In general, the value of the Vnf-Ve voltage is close to a discharge firing voltage Vf between the scan electrode Y and the sustain electrode X, and therefore a wall voltage difference between the scan electrode Y and the sustain electrode X becomes close to 0V so that misfiring of cells that have been addressed during the address period can be prevented during a sustain period.

In FIG. 3, while it is illustrated that the reset period includes the rising period and the falling period, the rising period of the reset period may be selectively provided to each subfield. That is, the rising period of the reset period may or may not be provided during each subfield.

During the address period, a scan pulse having a VscL voltage is sequentially applied to a plurality of scan electrodes Ys while the Ve voltage is applied to the sustain electrode X so as to select light emitting cells. Simultaneously, an address voltage is applied to the address electrode A of the cell to which the VscL voltage is applied. Accordingly, an address discharge is generated between the scan electrode Y and each of the address electrode A and the sustain electrode X to which the VscL voltage is applied. As a result, positive wall charges are formed on the scan electrode Y and negative wall charges are formed on the address electrode A and the sustain electrode X. In this case, the VscL voltage is lower than the Vnf voltage by a voltage ΔV. In addition, the scan electrode driver 400 recovers the voltage ΔV and supplies the voltage to neighboring circuits so that power consumption may be greatly reduced. The scan electrodes Y of other cells, to which the VscL voltage is not applied, is applied with a VscH voltage (non-scan voltage) that is greater than the VscL voltage, and the address electrodes of unselected discharge cells are applied with the reference voltage.

During the sustain period, a sustain discharge pulse alternately having a high level voltage (Vs voltage in FIG. 3) and a low level voltage (0V in FIG. 3) is applied to the scan electrode Y and the sustain electrode X. The sustain pulse phase applied to the scan electrode Y is opposite to the sustain pulse phase applied to the sustain electrode X. Accordingly, the 0V voltage is applied to the sustain electrode X when the Vs voltage is applied to the scan electrode Y, and the 0V voltage is applied to the scan electrode Y when the Vs voltage is applied to the sustain electrode X. As a result, discharge is generated in the scan electrode Y and the sustain electrode Y because of the wall voltage and the Vs voltage. The wall voltage is formed between the scan electrode Y and the sustain electrode X due to the address discharge and the Vs voltage. Processes for applying the sustain discharge pulse to the scan electrode Y and the sustain electrode X are repeated a number of times corresponding to a weight of the corresponding subfield.

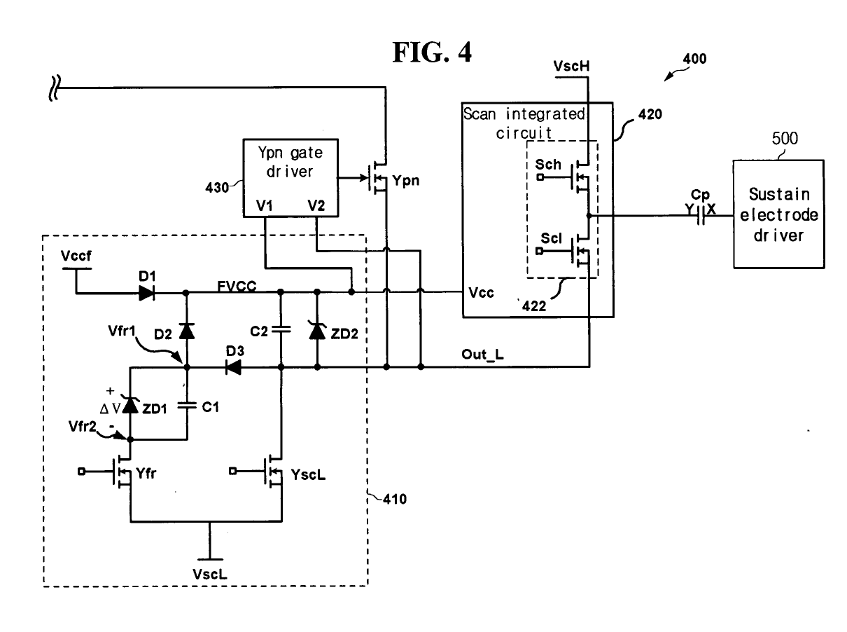

A driving circuit in the scan electrode driver according to the embodiment will be described with reference to FIG. 4. While the scan electrode driver 400 according to the embodiment further includes a plurality of driving circuits for realizing the driving waveform shown in FIG. 3, a part of the scan electrode driver 400 for realizing the driving waveform from the falling period of the reset period to the address period is illustrated in FIG. 4.

FIG. 4 is a diagram representing a part of the scan electrode driver 400.

As shown in FIG. 4, the scan electrode driver 400 includes a Vnf and VscL voltage supply unit 410, a scan integrated circuit 420, a Ypn gate driver 430, and a transistor Ypn.

The Vnf and VscL voltage supply unit 410 includes diodes D1, D2, and D3, Zener diodes ZD1 and ZD2, capacitors C1 and C2 and transistors Yfr and YscL.

An anode of the diode D1 is coupled to a power source Vccf for supplying a Vccf voltage, a cathode of the diode D2 is coupled to a cathode of the diode D1, and a terminal of the capacitor C2 is coupled to the cathode of the diode D1. An anode of the diode D3 is coupled to another terminal of the capacitor C2, and a cathode of the diode D3 is coupled to an anode of the diode D2. A cathode of the Zener diode ZD1 is coupled to the anode of the diode D2. A drain of the transistor Yfr is coupled to an anode of the Zener diode ZD1, and a source of the transistor Yfr is coupled to a power source VscL for supplying a VscL voltage. A terminal of the capacitor C1 is coupled to the anode of the diode D2, and another terminal of the capacitor C1 is coupled to the anode of the Zener diode ZD1. A drain of the transistor YscL is coupled to the anode of the diode D3, and a source of the transistor YscL is coupled to the power source VscL for supplying the VscL voltage. In addition, a cathode of the Zener diode ZD2 is coupled to the cathode of the diode D1, and an anode of the Zener diode ZD2 is coupled to anode of the diode D3.

The scan integrated circuit 420 includes a selection circuit 422, and receives a voltage charged in the capacitor C2 as a power source voltage Vcc.

The selection circuit 422 includes a transistor Sch having a drain coupled to a power source VscH for supplying a VscH voltage and a source coupled to the scan electrode Y, and a transistor Scl having a drain coupled to the scan electrode Y and a source coupled to the anode of the Zener diode ZD2.

The Ypn gate driver 430 uses a V1 voltage and a V2 voltage that are voltages of both terminals of the capacitor C2 to generate a gate control signal for turning on/off the transistor Ypn according to the control signal from the controller 200 shown in FIG. 2. Here, the transistor Ypn controls electrical connection between the plurality of driving circuits (not shown in FIG. 4) and the scan electrode Y during the reset and sustain periods.

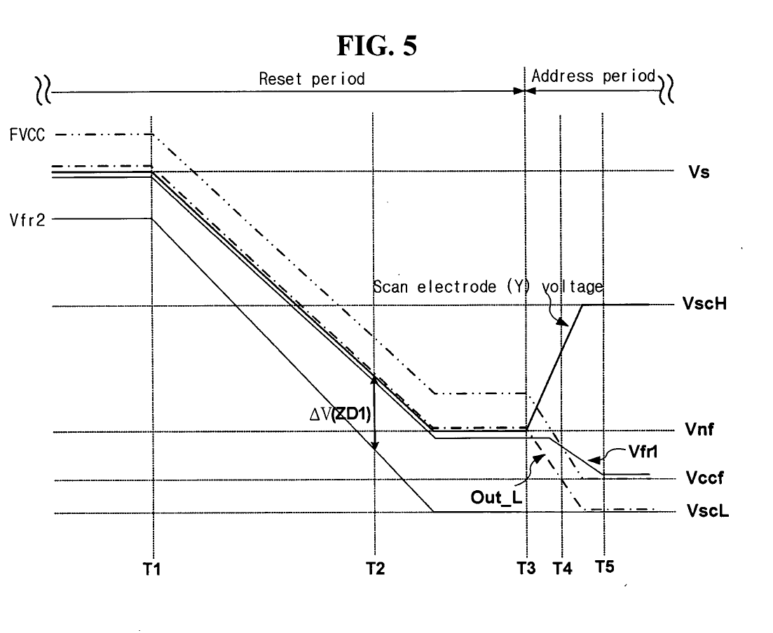

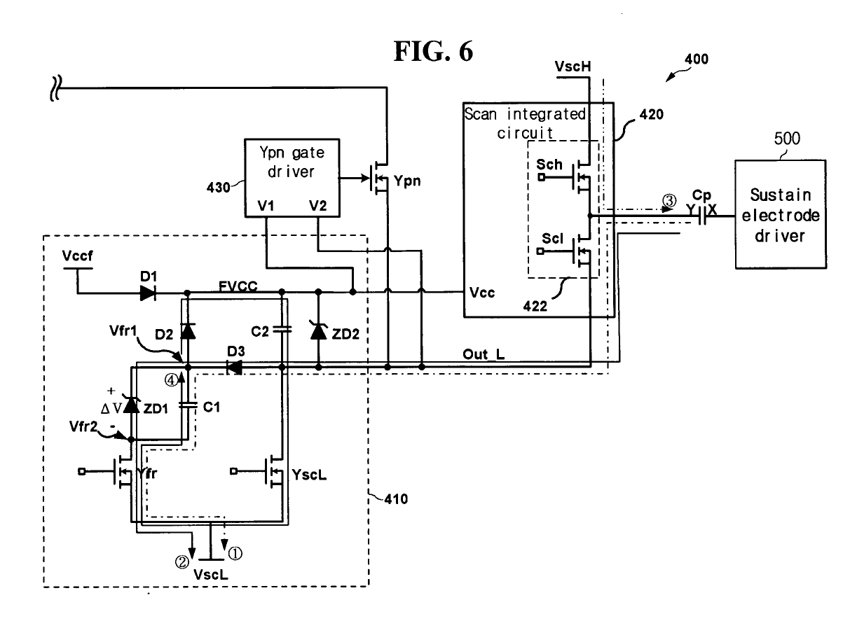

An operation of the scan electrode driver 400 shown in FIG. 4 will now be described with reference to FIG. 5 and FIG. 6.

FIG. 5 is a detailed diagram representing driving waveforms from the falling period of the reset period to the address period among the driving waveforms shown in FIG. 3, and FIG. 6 is a diagram representing the scan electrode driver 400 showing first to fourth current paths \textcircled{1} to \textcircled{4} for realizing the driving waveforms shown in FIG. 5.

In FIG. 5, a Vfr1 voltage, a Vfr2 voltage, and an FVCC are voltage as shown in FIG. 6. In addition, before a time T1, it will be assumed that the transistor Ypn is turned on and the Vs voltage is applied to the scan electrode Y.

When the transistors Scl and Yfr are turned on at the time T1 shown in FIG. 5, the first current path \textcircled{1} shown in FIG. 6 is formed from the scan electrode Y to the power source VscL through the diode D3, the capacitor C1, and the transistor Yfr.

At the time T1 when the transistors Scl and Yfr are turned on, the voltage at the scan electrode Y, the Vfr1 voltage, and a voltage of an Out_L line have substantially the same voltage level (i.e., the Vs voltage), and the FVCC voltage is greater than the voltage of the Out_L line by the breakdown voltage of the Zener diode ZD2.

When a current flows through the first current path \textcircled{1} since the transistors Scl and Yfr are turned on, the voltage at the scan electrode Y is decreased from the Vs voltage, and the voltage is charged in the capacitor C1. In this case, the Vfr1 voltage, the FVCC voltage, and the voltage of the Out_L line are also decreased with the same slope as a falling slope of the voltage at the scan electrode Y.

Since the voltage at the scan electrode Y decreases, a weak discharge is generated between the scan electrode Y and the sustain electrode X and between the scan electrode Y and the address electrode A. Charges required to perform the weak discharge vary according to the state of the PDP 100, and the capacitor C1 is set to be charged before the voltage at the scan electrode Y is decreased to the Vnf voltage (i.e., a time T2 in FIG. 5).

From the time T1 to the time T2 when the capacitor C1 is charged, the voltage difference between the terminals of the capacitor C1 (i.e., the Vfr1 voltage and the Vfr2 voltage) is continuously increased. Since the capacitor C1 is charged at the time T2, the current flowing through the first current path \textcircled{1} flows from the scan electrode Y to the power source VscL through the diode D3, the Zener diode ZD1, and the transistor Yfr (i.e., the second current path \textcircled{2}).

Since the current flows through the second current path \textcircled{2} from the time T2, the voltage at the scan electrode Y, the Vfr1 voltage, and the voltage of the Out_L line are decreased to the Vnf voltage. Here, the Vnf voltage is greater than the VscL voltage by ΔV that is the breakdown voltage of the Zener diode ZD1. In this case, the voltage at the scan electrode Y, the Vfr1 voltage, and the voltage of the Out_L line are the same, and the FVCC voltage is greater than the voltage of the Out_L line by the breakdown voltage of the Zener diode ZD2. In addition, the Vfr2 voltage is decreased to the VscL voltage, and the voltage difference between the terminals of the capacitor C1 (i.e., the Vfr1 voltage and the Vfr2 voltage) is maintained to be the breakdown voltage of the Zener diode ZD1 (i.e., ΔV).

At a time T3, the transistor Sch is turned on and the transistor Scl is turned off. Accordingly, the reset period is finished and the address period is started. In this case, while the transistor Yfr is maintained to be turned on, the transistor YscL is turned on.

Since the transistor Sch is turned on, the current flows through the third current path \textcircled{3} of the power source VscH, the transistor Sch, and the scan electrode Y, and the voltage at the scan electrode Y is increased. In addition, since the transistor Scl is turned off and the transistor YscL is turned on, the voltage of the Out_L line is decreased to the VscL voltage. In this case, since the FVCC voltage is greater than the voltage of the Out_L line by the breakdown voltage of the Zener diode ZD2, the FVCC voltage is decreased to the Vccf voltage according to the decrease of the voltage of the Out_L line. In this case, while the Vfr2 voltage is maintained to be VscL voltage, the Vfr1 voltage is maintained, from the time T1 to the time T2, to be the Vnf voltage that is greater than the Vfr2 voltage by the voltage charged in the capacitor C1.

At a time T4, the FVCC voltage that started to decrease at the time T3 becomes lower than the Vfr1 voltage. When the FVCC voltage becomes lower than the Vfr1 voltage, the current flows from the terminal of the capacitor C1 to which the Vfr1 voltage is applied to the other terminal of the capacitor C1 through the diode D2, the capacitor C2, the transistor YscL, and the transistor Yfr (i.e., through the fourth current path \textcircled{4}). Since the current flows through the fourth current path \textcircled{4}, the Vfr1 voltage is decreased, and the voltage charged in the capacitor C1 is recovered to the capacitor C2. After the time T4, the FVCC voltage is continuously decreased and is maintained to be the Vccf voltage by the power source Vccf for supplying the Vccf voltage, and the voltage of the Out_L line is decreased to the VscL voltage.

At a time T5, the Vfr1 voltage is decreased to the Vccf voltage. Since the Vfr1 voltage is decreased to the Vccf voltage, the current flowing through the fourth current path \textcircled{4} stops. From the time T4 to the time T5 when the current flows through the fourth current path \textcircled{4}, the voltage charged in the capacitor C1 is recovered to the capacitor C2.

The voltage recovered to the capacitor C2 is supplied to the scan integrated circuit 420 and the Ypn gate driver 430, and therefore the voltage supplied to the scan electrode driver 400 from the power source Vccf may be reduced. In addition, a scan electrode driver 400 driven by low power may be realized.

In FIG. 6, the diode D1 prevents a backward current toward the power source Vccf. In addition, the Zener diode ZD2 suppresses the voltage difference between both terminals of the capacitor C2 to not exceed a certain level, so as to protect the Ypn gate driver 430 from erroneous operation or from being damaged.

In the scan electrode driver, while the scan integrated circuit 420 and the Ypn gate driver 430 are examples, in other embodiments, a voltage charged in the capacitor C2 may be supplied to another driver or another integrated circuit to drive the scan electrode driver 400 with low power.

Since the scan electrode driver uses the power lost by the heat caused when the Zener diode ZD1 is used to apply the Vnf voltage to the scan electrode Y to charge the capacitor C2, and supplies the charged power to a gate driver or an integrated circuit of another switch as a power source, the plasma display may be driven by lower power.

According to some embodiments, since a capacitor is charged by recovering the power loss caused by the heat of a Zener diode used to supply a Vnf voltage, and the voltage charged in the capacitor is supplied to another circuit element, a plasma display having low power consumption and a driving method thereof may be realized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the embodiments.

What is claimed is:

1. A plasma display comprising:
a scan electrode;
a scan integrated circuit configured to apply a scan voltage received through a first terminal to the scan electrode and to apply a non-scan voltage through a second terminal to the scan electrode during an address period, wherein the non-scan voltage is greater than the scan voltage; and
a voltage supply unit configured to gradually decrease a voltage at the scan electrode to a first voltage during a reset period and to supply the scan voltage to the first terminal during the address period, wherein the first voltage is greater than the scan voltage,
wherein the voltage supply unit comprises:
a voltage generator electrically connected to the first terminal and configured to during the reset period, generate a second voltage by using the scan voltage; and
a first capacitor connected to a node of the voltage generator, to the first terminal, and to a power source input terminal of the scan integrated circuit, wherein the first capacitor uses the second voltage supplied from the voltage generator to drive the scan integrated circuit,
wherein the second voltage corresponds to a voltage difference between the first voltage and the scan voltage.

2. The plasma display of claim 1, wherein the voltage supply unit comprises:
a second capacitor connected to the voltage generator; and
a first switch that is connected between a terminal of the second capacitor and a first power source for supplying the scan voltage,
wherein the voltage generator is a first Zener diode including an anode connected to the second capacitor and the first switch, and a cathode connected to the first capacitor.

3. The plasma display of claim 2, wherein the voltage supply unit further comprises:
a first diode including an anode connected to the cathode of the first Zener diode and a cathode connected to the first capacitor;
a second diode including an anode connected to the first capacitor and a cathode connected to the cathode of the first Zener diode;
a second switch connected between the first capacitor and the first power source; and
a second Zener diode connected to across the first capacitor.

4. The plasma display of claim 3, wherein the scan integrated circuit comprises a third switch connected between the scan electrode and the first terminal of the scan integrated circuit, and the voltage supply unit is configured to turn on the first and third switches during a first period to gradually decrease the voltage at the scan electrode, wherein the first period is during the reset period.

5. The plasma display of claim 4, wherein the voltage supply unit is configured to generate a current through a first current path, and to charge the second capacitor with the second voltage during the first period, wherein the first current path comprises the scan electrode, the third switch, the second diode, the second capacitor, the first switch, and the first power source.

6. The plasma display of claim 5, wherein the first voltage is a breakdown voltage of the first Zener diode.

7. The plasma display of claim 5, wherein, during the first period, the voltage supply unit is configured to generate a current through a second current path of the scan electrode to decrease the voltage at the scan electrode to the first voltage, wherein the second current path includes the third switch, the second diode, the first Zener diode, the first switch, and the first power source.

8. The plasma display of claim 7, wherein the voltage supply unit is configured to:
turn off the third switch and turn on the first and second switches at the beginning of the address period; and
generate current through a third current path when a voltage at the cathode of the first diode becomes lower than the first voltage, to recover the second voltage to the first capacitor, wherein the third current path comprises another terminal of the second capacitor, the first diode, the first capacitor, the second switch, the first power source, the first switch, and the terminal of the second capacitor.

9. A driving method of a plasma display comprising a Zener diode including a cathode electrically connected to a scan electrode, a first switch connected between the anode of the Zener diode and a first power source configured to supply a scan voltage, and a second switch electrically connected between the scan electrode and the first power source, the driving method comprising:
during a reset period, turning on the first switch to charge a breakdown voltage of the Zener diode to a first capacitor connected in parallel to the Zener diode;
during an address period, turning on the second switch to recover the breakdown voltage to a second capacitor including a terminal connected to a node of the scan electrode and the second switch, and another terminal connected to the first capacitor; and
during the address period, supplying the recovered breakdown voltage to a neighboring circuit as a power source voltage.

10. The method of claim 9, wherein the plasma display further comprises a plasma display panel, and the neighboring circuit comprises a scan integrated circuit configured to charge and discharge the plasma display panel, and the method further comprises charging and discharging the plasma display panel with the scan integrated circuit.

11. The method of claim 10, wherein the first and second switches are configured to discharge the plasma display panel during the reset period and during the address period, respectively.

12. A plasma display comprising:
a scan electrode;
a scan driver circuit, comprising:
a Zener diode;
a first capacitor connected in parallel with the Zener diode;
a first switch, configured to be turned on during a reset period to apply a reset voltage to the scan electrode, wherein the first capacitor is charged to the breakdown voltage of the Zener diode; and
a second switch, configured to be turned on during an address period to apply a scan voltage to the scan electrode, wherein the capacitor is discharged.

13. The plasma display of claim 12, wherein the scan driver circuit is configured to charge the first capacitor to the breakdown voltage of the Zener diode by providing a current to the parallel combination of the first capacitor and the Zener diode, wherein the current charges the first capacitor until the capacitor is charged to the breakdown voltage of the Zener diode.

14. The plasma display of claim 13, wherein the current provided to the parallel combination discharges the scan electrode.

15. The plasma display of claim 12, further comprising a second capacitor, wherein the scan driver circuit is configured to discharge the first capacitor by providing a current from the parallel combination of the first capacitor and the Zener diode, wherein the current charges the second capacitor.

16. The plasma display of claim 15, wherein the current provided from the parallel combination discharges the scan electrode.

17. The plasma display of claim 15, further comprising a scan integrated circuit, connected to the scan electrode, wherein the second capacitor is connected to a power source input terminal of the scan integrated circuit, and the second capacitor uses charge supplied from the first capacitor to drive the scan integrated circuit.

18. The plasma display of claim 17, wherein the scan integrated circuit is configured to charge and to discharge the scan electrode.

19. The plasma display of claim 12, further comprising a scan integrated circuit, connected to the scan electrode, wherein the scan driver circuit comprises a second capacitor connected to a power source input terminal of the scan integrated circuit, wherein the second capacitor uses charge supplied from the first capacitor to drive the scan integrated circuit.

20. The plasma display of claim 19, wherein the scan integrated circuit is configured to charge and to discharge the scan electrode.
